(19) United States
(12) Patent Application Publication
(10) Pub. No.: US 2019/0266788 A1
(43) Pub. Date: Aug. 29, 2019

(54) SYSTEM AND METHOD OF RENDERING A SURFACE

(71) Applicant: CANON KABUSHIKI KAISHA, Tokyo (JP)

(72) Inventors: THAI QUAN HUYNH-THU, Edgecliff (AU); MATTHEW RAPHAEL ARNISON, Umina Beach (AU); ZOEY ISHERWOOD, Zetland (AU); JUNO KIM, Bexley (AU); VANESSA JEANIE HONSON, Karela (AU)

(21) Appl. No.: 16/284,860

(22) Filed: Feb. 25, 2019

(30) Foreign Application Priority Data
Feb. 28, 2018 (AU) 2018201472

(51) Int. Cl. G06T 15/40; G06F 17/50; G06T 7/60; G06K 9/62

(52) U.S. Cl. CPC G06T 15/405; G06F 17/5018; G06K 9/6212; G06K 9/6202; G06T 7/60

(57) ABSTRACT

A system and method of rendering an image of a surface. The method includes receiving a user input modifying a material appearance parameter of the surface related to perceived gloss; determining a weighting coefficient for each of a plurality of pixel values of the surface using a corresponding normal, viewing angle and a position of a light source, wherein the pixel values are determined using the modified material appearance parameter; and determining perceived coverage of the surface by specular highlights based on the pixel values weighted using the corresponding weighting coefficients. The method also includes rendering the image using colour properties adjusted based on the determined coverage, to maintain perceived colour properties and update perceived gloss based on the modification.

### REFERENCE TO RELATED APPLICATION(S)

This application claims the benefit under 35 U.S.C. § 119 of the filing date of Australian Patent Application No. 2018201472, filed 28 Feb. 2018, hereby incorporated by reference in its entirety as if fully set forth herein.

### TECHNICAL FIELD

The present invention relates to a method of and an apparatus of image processing for simulating, visualizing, and editing the surface appearance of a material on a computer monitor.

### BACKGROUND

Accurate colour editing and reproduction is a mature technology in the field of two dimensional (2D) printing, especially for diffuse colour reproduction and printing. However, reproduction of only colour restricts the representation of a wide range of material appearances, including reflective properties such as for shiny metallic surfaces. The sole use of colour to represent a reflective characteristic such as a shiny metallic surface leads to a dull plastic appearance when under varying illumination and viewing conditions. Recent 2D printing systems have added further capabilities to control optical properties of the printed surface and improve the reproduction of material appearance, including but not limited to angular-dependent reflection properties of the print and translucency.

Furthermore, in recent years, 2.5 dimensional (2.5D) and three dimensional (3D) rendering and printing technologies have emerged. 2.5D printers allow printing a limited height relief, similar to the height relief of oil paintings, and 3D printers allow printing objects with arbitrary shapes. In many 2.5D and 3D applications, the appearance of the surface of the object is of high importance. In 2.5D printing, the appearance of the surface of the object plays a crucial role in the perception and value of the object. Characteristics affecting surface appearance, such as diffuse colour, highlight/reflection colour, glossiness, roughness and colour travel, impact the user's perception of the appearance of that object or surface. Current applications of such technology include artwork reproduction, design, and high-quality packaging, where appearance can vary across the surface, e.g. from matte/dull to shiny/glossy. In 3D printing, there is an increased need to produce printed objects with a realistic material appearance.

For example, artwork reproduction of oil paintings is used for educational purposes and requires a precise replication of surface texture and gloss to recreate the artist's original painting. Cultural heritage can be digitally preserved by 3D scanning the art object and requires the scanning of not only the colour information of the surface of the object but also of the precise relief of the surface and light reflectance characteristics of the surface. An oil painting typically exhibits a certain gloss that contributes to the artistic intent and therefore needs to be captured in the digital scan, and reproduced physically if the scanned object is printed. Once the object is digitally imported into a computer, the object then needs to be digitally processed before printing. Colours and other appearance aspects of the surface may need adjustment. In another example of object design, the user designs an object and the object's appearance using a computer-aided design (CAD) software tool and wants to manipulate the surface appearance of the object to a desired effect, such as giving a glossy metallic effect to the surface.

Virtual reality and augmented reality technologies place computer-generated objects in a real-world scene for various simulation scenarios, such as gaming or on-line shopping. In gaming or on-line shopping applications, the goal is to allow users to interact with a virtual object placed in the context of a real-world 3D scene in front of them. The realism of the rendered object in the scene is crucially important for user experience. For example, a shiny coloured surface of an object needs to look consistently glossy and colourful for the given viewing direction and lighting direction as the user moves the object in the scene or as the user moves around the object in the scene.

Colour editing and management is a known practice in the printing industry workflow. However, controlling additional aspects related to the optical characteristics of the surface is still a technical challenge. In general, designers rely on CAD software tools to produce or reproduce a desired surface appearance, sometimes termed ‘look and feel’.

In a typical scenario, a user wants to design an object and the object's surface appearance, for example an object with a coloured surface and glossy reflection aspect. A computer-aided design software tool is often used to design the shape of the object in the form of a 3D mesh of polygons. The same software or different software is used to apply a texture on the 3D mesh and to manipulate the surface appearance. The texture, with specific geometric variations, can be chosen from a library of examples to be applied on the surface of the object. Parameters related to geometry of the surface, such as bumpiness, graininess, are set by the user. Additionally, physical parameters related to the behaviour of the surface in relation to light reflections can be set by the user. Physical parameters affecting the reflective properties of the surface will influence the perceived appearance of the surface. Physical parameters related to perceived surface appearance, such as diffuse colour, reflectivity, roughness, and gloss are manually set by the user until the user is satisfied by the appearance as simulated on the computer monitor. Each parameter is controlled independently from all other parameters. In particular, surface geometry is controlled independently to the reflectance characteristics of the surface, and colour is controlled independently from surface reflectance characteristics such as gloss. In conventional tools, knowing which parameter(s) to modify and how to modify the parameter(s) requires a high level of expertise and experience with such tools. The parameters are either directly mapped to mathematical parameters in the rendering model or represent low-level physical parameters, and are therefore not intuitive to understand in terms of their effect on surface appearance.

In conventional material appearance editing tools, adjustment of material colour is made independently of other surface appearance parameters, such as specular roughness, and independently from surface geometry. In these conventional methods, the user has access to a number of colour adjustment parameters such as the RGB (red green blue) values of a colour, or colour properties such as hue, lightness, chroma or saturation. In a scenario where the object is intended to be printed or manufactured, it is desirable for the rendering system to provide a preview of the result of the print. In such cases, the simulated material is digitally displayed so that the user can have a precise idea of the finished state of the edited material. The user previews the edited material in order to judge and confirm the target appearance, including perceived colour and reflectance properties of the surface. The preview function is important to reduce the number of printing trials and errors otherwise needed by the user to obtain the desired printed appearance. In the absence of a preview function, the user needs to print the current edited material, and confirm if the result is as the user desired. If this is not the case, the user needs to modify some material appearance settings, print again and visually confirm again if the printing result matches the user's expectation. The development process can therefore be time-consuming and expensive to achieve a desired material appearance. A preview function can reduce substantially the time and cost of achieving a desired printed material appearance.

Conventional methods of material appearance editing such as CAD tools offer a high number of parameters to manipulate the surface appearance. However, these parameters are manipulated independently and do not represent how humans perceive light scattering information and interpret this information to form a judgment of material appearance. As 3D and 2.5D rendering and printing become more widely available, the need to create and modify the appearance of materials is spreading to a wider range of users, often not specialised or familiar with graphics parameters. The surface parameters are not easily understandable by non-expert users and the difficulty such users have in predicting the effect on the material appearance often leads to time-consuming trial-and-error approaches to set their values.

### SUMMARY

It is an object of the present invention to substantially overcome, or at least ameliorate, one or more disadvantages of existing arrangements.

One aspect of the present disclosure provides a method of rendering an image of a surface, the method comprising: receiving a user input modifying a material appearance parameter of the surface related to perceived gloss; determining a weighting coefficient for each of a plurality of pixel values of the surface using a corresponding normal, viewing angle and a position of a light source, wherein the pixel values are determined using the modified material appearance parameter; determining perceived coverage of the surface by specular highlights based on the pixel values weighted using the corresponding weighting coefficients; and rendering the image using colour properties adjusted based on the determined coverage, to maintain perceived colour properties and update perceived gloss based on the modification.

In another aspect, the adjusted colour properties relate to at least one of colour saturation and colour lightness.

In another aspect, the user input modifying a material appearance parameter relates to at least one of modifying a mesoscale structure of the material, modifying physical gloss of the material, and modifying specular roughness of the material.

In another aspect, the mesoscale structure relates to one of bumpiness and height.

In another aspect, the user input modifies a mesoscale geometry of the material, and a specular roughness parameter is adjusted to maintain a perceived colour saturation of the surface.

In another aspect, the specular roughness is adjusted using a polynomial function of the parameters modified by the user input, and coefficients of the polynomial function are obtained from psychophysical experiment data.

In another aspect, a ratio of an updated perceived colour property to an initial perceived colour property is used to modify a diffuse colour property of the surface to thereby maintain the perceived colour properties.

In another aspect, the adjusted specular roughness parameter is determined from a look-up-table derived from psychophysical experiment data.

In another aspect, the coverage of the surface by specular highlights is determined by comparing each weighted pixel to a pre-determined threshold.

In another aspect, the threshold is determined according to surface reflectance properties, surface diffuse colour and lighting environment information.

In another aspect, perceived colour properties are determined as a weighted combination of the perceived coverage and perceived gloss.

In another aspect, the weighting comprises mapping normals of each pixel to a greyscale intensity.

In another aspect, the colour properties are adjusted across R, G, and B colour channels.

In another aspect, the method further comprises estimating a perceived colour saturation for given colour and gloss prior to receiving the user input.

In another aspect, perceived colour saturation is determined as a linear combination of statistics of specular coverage or statistics of specular content of the weighted pixels.

In another aspect, the colour properties are adjusted by adjusting colour saturation using a polynomial function, the coefficients of the polynomial function being determined from psychophysical experiment data.

In another aspect, the colour properties are adjusted by adjusting colour saturation using a look-up-table representing a mapping between colour saturation and material appearance parameters relating perceived gloss.

Another aspect of the present disclosure provides apparatus, comprising: a processor; and a memory device storing a software program for directing the processor to perform a method for rendering an image of a surface, the method comprising the steps of: receiving a user input modifying a material appearance parameter of the surface related to perceived gloss; determining a weighting coefficient for each of a plurality of pixel values of the surface using a corresponding normal, viewing angle and a position of a light source, wherein the pixel values are determined using the modified material appearance parameter; determining perceived coverage of the surface by specular highlights based on the pixel values weighted using the corresponding weighting coefficients; and rendering the image using colour properties adjusted based on the determined coverage, to maintain perceived colour properties and update perceived gloss based on the modification.

Another aspect of the present disclosure provides a system comprising: a processor; and a memory device storing a software program for directing the processor to perform a method of rendering an image of a surface, the method comprising the steps of: receiving a user input modifying a material appearance parameter of the surface related to perceived gloss; determining a weighting coefficient for each of a plurality of pixel values of the surface using a corresponding normal, viewing angle and a position of a light source, wherein the pixel values are determined using the modified material appearance parameter; determining perceived coverage of the surface by specular highlights based on the pixel values weighted using the corresponding weighting coefficients; and rendering the image using colour properties adjusted based on the determined coverage, to maintain perceived colour properties and update perceived gloss based on the modification.

Another aspect of the present disclosure provides a non-transient computer readable storage medium storing program instructions to implement a method of: reproducing, via a graphical user interface, an initial image of the surface; receiving, via the graphical user interface, a user input modifying perceived gloss of the surface; determining a colour saturation value corresponding to the received user input, wherein the colour saturation value varies depending on perceived gloss of the surface associated with the user input; rendering, via the user interface, the image using colour properties adjusted based on the determined colour saturation, to maintain perceived colour saturation and update perceived gloss based on the modification; and displaying the rendered image via the graphical user interface.

In another aspect, the colour properties are adjusted based upon a perceived specular coverage of the surface.

Other aspects are also described.

### BRIEF DESCRIPTION OF THE DRAWINGS

One or more embodiments of the invention will now be described with reference to the following drawings, in which:

FIGS. 1 and 2 form a schematic block diagram of a general purpose computer on which the arrangements described may be practised;

FIG. 3 illustrates specular highlight characteristics affecting gloss;

FIG. 4 shows an example of a method of modifying material appearance according to an embodiment;

FIG. 5 is a schematic flow diagram illustrating a method of determining perceived specular coverage;

FIG. 6 shows an example of a user interface implementing the method of modifying material appearance;

FIG. 7 illustrates parameters of a bidirectional reflectance distribution function (BRDF);

FIG. 8 shows an example of microscale, mesoscale and macroscale geometry of an object.

FIG. 9 provides an illustrative example of a pattern coded representation of surface normals for a 3D sphere and a 2.5D surface;

FIG. 10 shows a method of modifying material appearance according to another embodiment;

FIG. 11 shows a method of rendering an input surface geometry with a material appearance into an output pixel buffer;

FIG. 12 shows a method of determining perceived colour; and

FIG. 13 shows a method of rendering an input surface geometry with a material appearance.

FIG. 14, which includes FIGS. 14A to 14C, shows results of an implementation of the method determining perceived specular coverage.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

Light reflected from a surface is used by humans to infer the physical properties of surfaces (e.g. shape, colour, gloss). Specular highlights on a surface provide an important visual cue to human observers to understand the reflective properties of surfaces. Various physical parameters can be manipulated during design or fabrication to modify the reflective properties of a surface and therefore impact the specular highlights on a surface. The relationship between physical properties of a surface and perceived appearance of that surface is highly complex. In particular, physical parameters can interact to produce a perception of the appearance.

The arrangements described relate to a method of rendering a graphical object in response to a modification of material appearance parameters. In particular, the described methods maintain a perceived colour (for example using colour lightness, saturation and hue) when material appearance parameters affecting perceived gloss (shine, gloss, bumpiness and mesoscale height) are modified.

The arrangements described address the role of specular highlights in the perception of gloss and perception of colour, and how perceived specular highlights and coverage can be determined automatically from images of naturally colourful surfaces.

According to the arrangements described, surface normal orientations and luminance information are jointly used to automatically determine the perceived coverage of specular highlights of a surface with mesoscale shape variations. The perceived coverage is used to model the impact of physical surface properties on the perceived colour of a surface.

The methods described are performed in response to the user modifying a physical parameter which affects the perceived material appearance of the surface of an object, such as a modification of a physical parameter affecting the perceived gloss of the surface of an object. Geometric information is used to weight luminance information to determine perceived specular highlights. In typical scenarios, a user is assumed to observe the surface of an object in a lighting environment where the light is placed above the object, that is along the vertical or zenith axis. The methods described herein automatically determine a prediction of perceived specular coverage and provide a user with the capability to maintain the same perceived surface colour appearance following modification of the surface gloss.

The methods described herein provide an improvement over existing arrangements in distinguishing bright matte pixels from specular pixels.

The arrangements described relate to the editing and manipulation of the appearance of a material surface on a computer monitor by using image processing techniques, while a digital representation of the surface of a material is simulated and visualized or rendered using the software. The surface appearance varies according to different characteristics, such as reflectivity and roughness, surface shape, illumination conditions and viewing angles.

The arrangements described provide a user with a method and an intuitive interface for manipulating the appearance of a surface, where several parameters controlling the surface appearance interact to produce the appearance. The arrangements described relate to a method to automatically determine the perceived specular coverage of a mesoscale varying surface, in order to substantially maintain the same surface colour appearance following modification of the surface gloss.

The arrangements described relate to preservation of appearance characteristics of a surface as perceived by a user, also referred to as perceptual appearance characteristics. In the context of the present application, the perceptual appearance characteristics can relate to gloss and colour.

Gloss, as described further below, represents whether a surface of an object appears polished to the user and has sharp specular reflections. Colour relates to how saturated or light colours are perceived to be and in some instances relates to a variety of colours of the surface. The characteristics of specular reflections influence perceived gloss and perceived colour. For example, the sharpness of specular reflections influences perception of colour lightness, as well as the perceived distinction between diffuse and specular information. Congruence between diffuse and specular information also influences perceived gloss. Shine is similar to gloss but relates more to reflected light than gloss.

In the arrangements described the surface relates to a surface of a graphical object representing an object formed of a particular material. The graphical object is generated, stored and manipulated by a user interacting with an interface executing on a computer system.

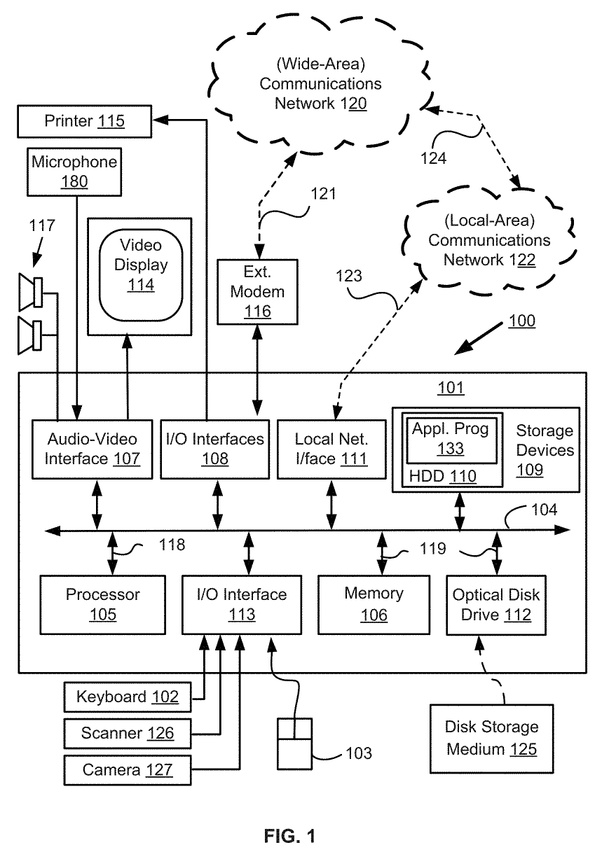

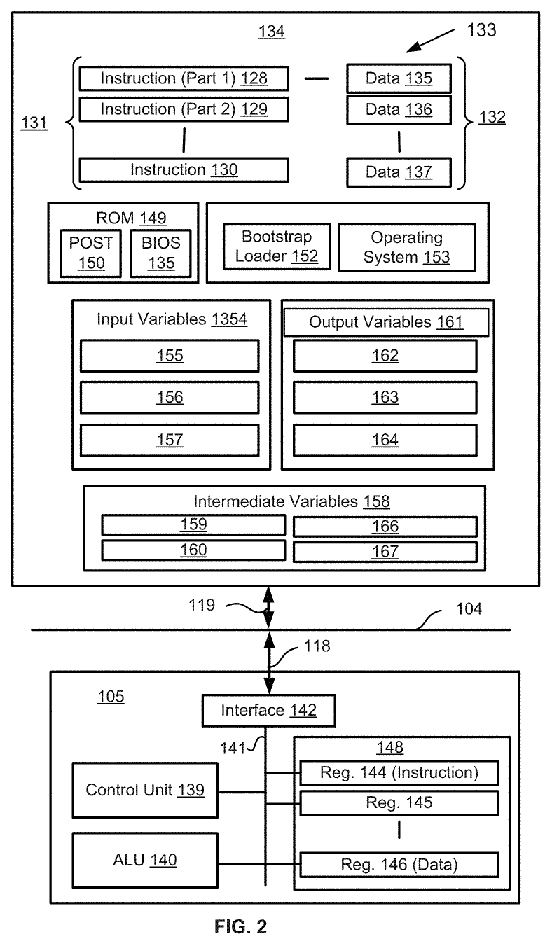

FIGS. 1 and 2 depict a general-purpose computer system 100, upon which the various arrangements described can be practiced.

As seen in FIG. 1, the computer system 100 includes: a computer module 101; input devices such as a keyboard 102, a mouse pointer device 103, a scanner 126, a camera 127, and a microphone 180; and output devices including a printer 115, a display device 114 and loudspeakers 117. An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 is typically a desktop computer, a laptop computer or a server computer. In some arrangements, the module 101 is a portable device, such as a tablet device.

The computer module 101 typically includes at least one processor unit 105, and a memory unit 106. For example, the memory unit 106 may have semiconductor random access memory (RAM) and semiconductor read only memory (ROM). The computer module 101 also includes a number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1, the local communications network 122 may also couple to the wide network 120 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or like computer systems.

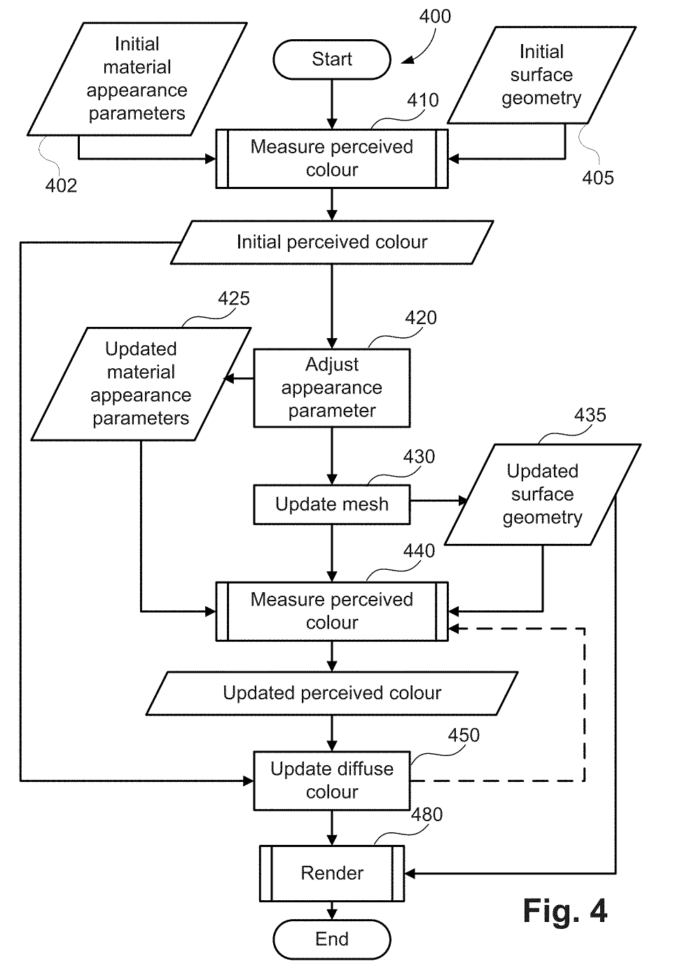

The methods described herein may be implemented using the computer system 100 wherein the processes of FIGS. 4, 5 and 10-13, to be described, may be implemented as one or more software application programs 133 executable within the computer system 100. In particular, the steps of the method of FIG. 2 are effected by instructions 131 (see FIG. 2) in the software 133 that are carried out within the computer system 100. The software instructions 131 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the computer program product in the computer system 100 preferably effects an advantageous apparatus for rendering a graphical object.

The software 133 is typically stored in the HDD 110 or the memory 106. The software is loaded into the computer system 100 from a computer readable medium, and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product. The use of the computer program product in the computer system 100 preferably effects an apparatus for rendering a graphical object.

In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 2 is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1.

When the computer module 101 is initially powered up, a power-on self-test (POST) program 150 executes. The POST program 150 is typically stored in a ROM 149 of the semiconductor memory 106 of FIG. 1. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1 must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 2, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1. The execution of a set of the instructions may in some cases result in output of data. Execution may also involve storing data or variables to the memory 134.

The arrangements described use input variables 154, which are stored in the memory 134 in corresponding memory locations 155, 156, 157. The described arrangements produce output variables 161, which are stored in the memory 134 in corresponding memory locations 162, 163, 164. Intermediate variables 158 may be stored in memory locations 159, 160, 166 and 167.

Referring to the processor 105 of FIG. 2, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises:
a fetch operation, which fetches or reads an instruction 131 from a memory location 128, 129, 130;
a decode operation in which the control unit 139 determines which instruction has been fetched; and
an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes of FIGS. 4, 5, 10, 11, 12, and 13 is associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

The method of rendering a graphical object may alternatively be implemented in dedicated hardware such as one or more integrated circuits performing the functions or sub functions of the arrangements described. Such dedicated hardware may include graphic processors, digital signal processors, or one or more microprocessors and associated memories.

Shape geometry of an object or surface is considered at three scales: microscale, mesoscale and macroscale.

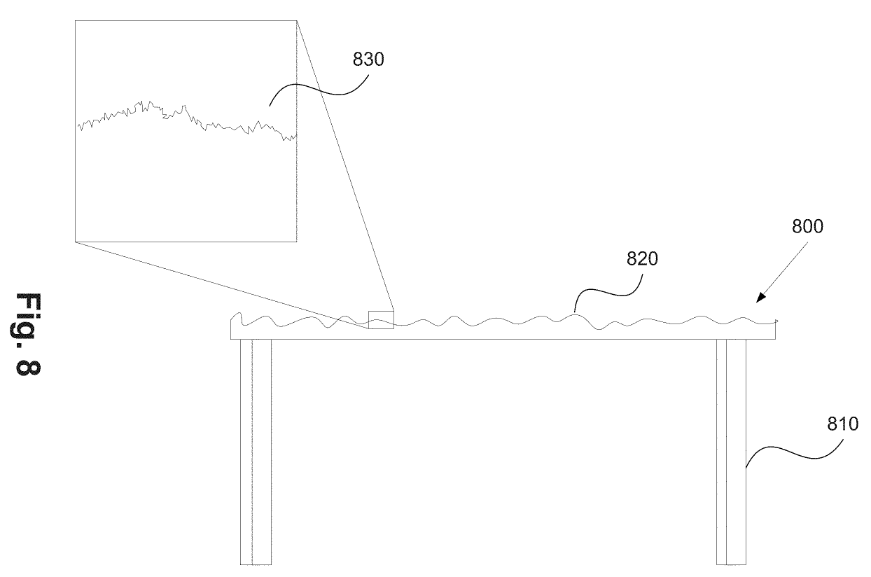

Macroscale geometry refers to the overall (3D) shape of an object. Referring to FIG. 8, a macroscale geometry 810 of a shape 800 is that the shape is a table with four legs.

Microscopic scale concerns surface geometry variations that are not visible to the human eye but contribute to the optical properties, such as reflectivity, of a surface, i.e. material being generated. In FIG. 8, an example hypothetical microscale geometry 830 is shown by zooming in to a particular part of the table 800, where small scale variation is shown which is not generally visible. The small scale variation gives the table a rougher appearance even though the individual variations are not visible.

Mesoscale surface patterns are spatial variations providing visible cues and defining the coarseness of a surface, for example grains of sand/wood, texture of a strawberry, coarseness of a brick, and bumpiness of a surface with relief variation. In FIG. 8, mesoscale geometry can be seen on a top surface 820 of the table 800. The mesoscale geometry can be seen where there is visible bumpiness to the surface. Mesoscale can be defined as the scale at which variations are visible upon close inspection, but do not change a viewer's sense of the overall shape of the object.

Specifically, mesoscale can be differentiated from microscale by whether variations are visible. For a real object, visibility may depend on viewing conditions, but mesoscale would be the scale at which variation is visible to the naked eye given the viewing conditions. For a rendering system, mesoscale is the scale at which variation in the shape is explicitly modelled in the object geometry such as the mesh itself or a normal map, while microscale is the scale at which variations are only considered in aggregate, such as by the reflective properties of the surface. Microscale variations, such as specular roughness, may be stored either as a global value for a material or as a texture map accompanying the mesh or the normal map. The texture map typically contains a two-dimensional (2D) array of local values (i.e. one value per pixel) for a particular microscale parameter.

Mesoscale can be differentiated from macroscale by whether the variations are considered part of the overall shape of the object. If, for example, two objects were made of different materials but were as similar in shape as practical otherwise, then the difference between those two objects would be a mesoscale difference. In a rendering system, the macroscale and mesoscale may be represented by a mesh and a normal map respectively. Alternatively macroscale and mesoscale may be represented by a coarse, base mesh and an offset from that mesh respectively. Alternatively, both may be represented by a single mesh structure, but mesoscale changes may be made using operations which approximately preserve the local average position.

Mesoscale patterns are often used to modify the “look and feel” of a material surface, without influencing the overall shape of the object and while maintaining fine scale reflective properties of the object. Visibility of mesoscale geometry is dependent on a viewing distance from the object. For example, non-smooth spatial variations on the surface can be visible at a close viewing distance but the surface can appear completely smooth at a longer viewing distance. The description of the light reflectance behaviour can therefore vary with the viewing distance. Humans can recognize material properties of a surface from light reflections on that surface. Light reflections on the surface and therefore optical properties of that surface are affected by both the mesoscale and microscale geometry variations. Mesoscale and microscale geometry variations influence the perception of a surface by a user, including the perceived gloss and perceived colour, for example perceived colour value or lightness, or perceived colour saturation or chroma. The effect may also be dependent on the macroscale surface orientation relative to viewing angle and light source. Macroscale surface orientation can be determined by averaging the direction of normals of the 3D mesh across a pre-determined area of the surface. For example, macroscale surface orientation has an effect on perceived colour and perceived gloss. Psychophysical data show that there is a main effect of macroscale surface orientation on perceived colour, a main effect of mesoscale relief height on perceived colour, a main effect of specular roughness on perceived colour, but there is also an interaction effect between macroscale surface orientation and specular roughness on perceived colour, and an interaction effect between mesoscale relief height and specular roughness on perceived colour. A three-way interaction between macroscale surface orientation, specular roughness and mesoscale relief height on perceived colour is also found. In other words, perceived colour can be affected by either a change of value of one of these factors or the combined change of values of two or three of these factors. However, in the context of designing the properties of a material to produce a desired surface appearance, the user will typically set the surface parameters, such as microscale roughness and mesoscale height, to satisfy a target appearance in given viewing conditions defined by the macroscale surface orientation relative to viewing angle and light source.

Mesoscale height relates to a parameter that makes all mesoscale structures higher in a direction normal to the macroscale surface variation. For example, mesoscale height can relate to relief height of a surface of the table 800. Frequency at mesoscale relates to bumpiness and to size, spacing and density of surface protrusions or bumps.

Light reflections of a surface relate to light scattering parameters of the surface, such as reflectivity and roughness of a bidirectional reflectance distribution function (BRDF) function of the material, as described below.

The reflective properties of the surface are represented by a mathematical function. The BSDF (Bidirectional Scattering Distribution Function) describes the interaction between incident light and object surface, i.e. how incident light is structured by the surface or medium. The term ‘Bidirectional’ refers to the relationship between the incident light direction and reflected light direction. The term ‘Scattering’ refers to how light incoming from a given direction is distributed by the material and the geometry of the surface. The BSDF includes (1) the BRDF (Bidirectional Reflectance Distribution Function), describing the light reflectance of a surface, (2) the BTDF (Bidirectional Transmittance Distribution Function), describing the light transmission through the surface, and (3) BSSRDF (Bidirectional Sub-surface scattering Reflectance Distribution Function), describing how light enters the material at one point and exits the material at another point. The BSDF reduces to BRDF for purely opaque surfaces. BTDF is necessary for modelling transparent objects. BSSRDF is necessary for modelling translucent objects. It is common practice to collapse the full BSDF representation of a surface into a more compact and simplified BRDF representation.

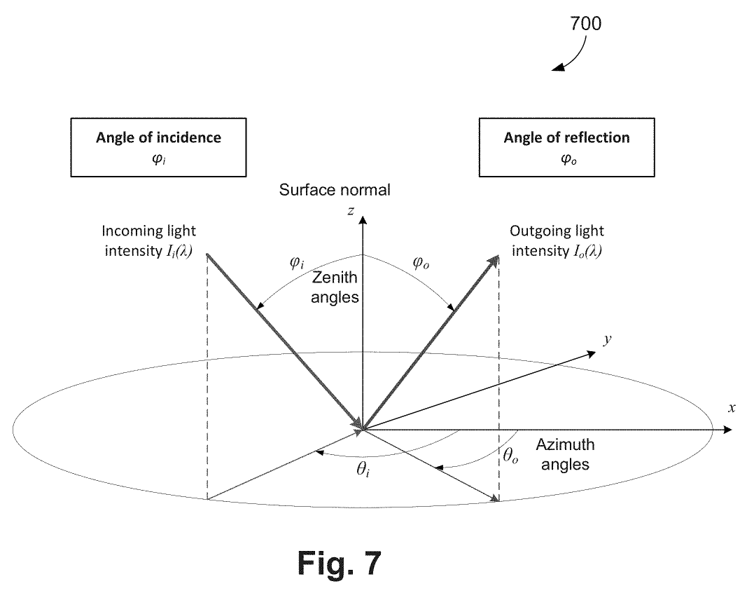

Furthermore, the BRDF is usually expressed into as an analytical function of 4 parameters (ignoring the wavelength of the light or polarisation) expressing the outgoing light as a function of the incoming light. Referring to FIG. 7, BRDF is determined in relation to four parameters, being azimuth (θᵢ) and zenith (φᵢ) angles of direction of incoming light relative to the surface normal, and azimuth (θₒ) and zenith (φₒ) angles of viewing direction relative to the surface normal. The BRDF is a function describing the reflective properties of a surface, represented with outgoing light as a function of incoming light, taking into account angle of incoming light onto the surface and angle of viewing of the surface. The surface normal is the vector perpendicular to the surface at that point. In the example of FIG. 7, the surface normal coincides with the zenith direction (z-axis) as the example surface is horizontal. However, when the surface has a non-zero slant, the surface normal is not aligned with the zenith direction but forms an angle with the zenith direction.

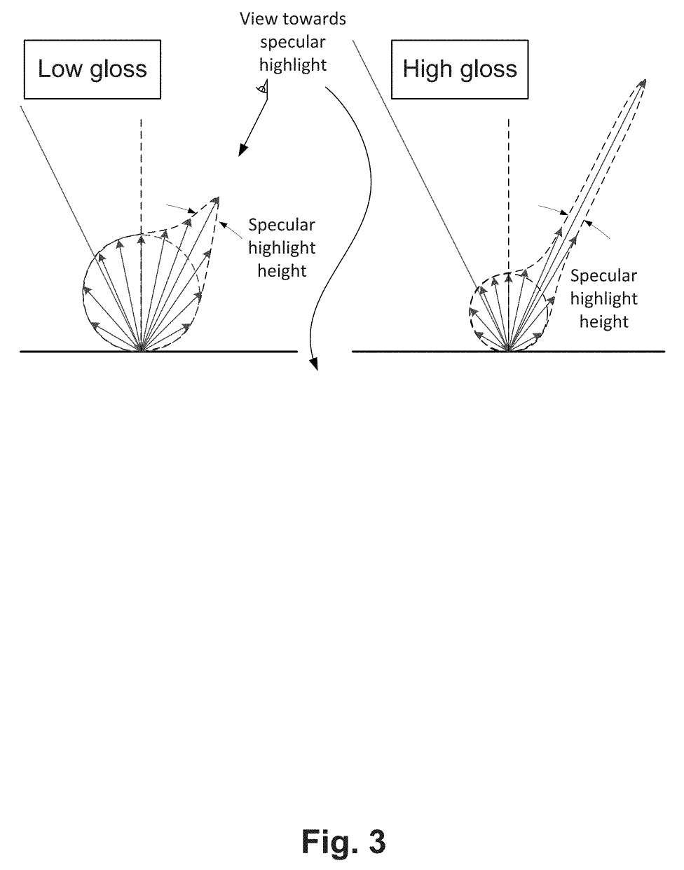

Many analytical models have been proposed to model the reflectance of the surface. A BRDF often includes 2 components. Firstly, a diffuse component models light absorption, subsurface interaction and internal reflections, and results in the colour of the surface. Secondly, a specular component models the direct reflection of light from the surface, and is related to glossiness or shininess of the surface. The strength and size of the specular reflection are often associated with the glossiness of the surface. The relationship of strength and size of specular reflection with glossiness is illustrated in FIG. 3. It is understood that the terms specular highlights and specular reflections are interchangeable.

As discussed previously, BRDF is used to represent the reflectivity properties of a surface. The BRDF can be extended to coloured surfaces using 3 BRDF functions, one for each of the red, green and blue (RGB) colour channels. As described above, diffuse components of BRDF relate to non-directional reflective properties, such as colour properties, and specular components relate to directional reflective properties. Alternatively, the colour of the diffuse and specular components of the BRDF may be represented using different weighting values for the R, G, and B colour channels. As such, the diffuse and specular components may have different colour values in the BRDF representation. While adjusting gloss relates to specular components, resultant adjustment of colour properties to maintain perceived colour can relate to adjusting three (R, G, B) channels.

As described previously, gloss is an important physical material characteristic related to surface reflectivity. Roughness can be defined as an amount of variation in surface shape. The appearance of physical texture is strongly dependent on the scale of the roughness variations. Roughness can be modelled at the microscale and mesoscale levels. At microscale level, texture variations are not visible but influence the optical properties of the surface: the smoother the surface (weaker roughness), the greater the amount of specular reflection, the glossier the surface appears. Conversely, the rougher the surface, the more diffuse the surface appears. Microscale roughness or specular roughness can be used in a BRDF model as a parameter of the reflection properties. The term specular roughness is commonly interchangeable with the term microscale roughness. Microscale roughness or specular roughness is referred to as simply roughness for the purposes of this disclosure.

Shape variations at the mesoscale level correspond to the physical texture of the material, and is referred to as bumpiness for the purposes of this disclosure. Adding bumps to a surface at a mesoscale gives the surface a rougher appearance. However, a bumpy material may also still appear glossy if the surface is smooth at the micro scale. Mesoscale height variation is a term that is commonly used to refer to surface geometry.

Some BRDF models are based on the concept of a microfacet distribution model. In microfacet distribution models, a surface is composed of microfacets (micro-level surfaces with individual orientations) and each of the microfacets reflects light in a direction based on the microfacet's normal. If all or most microfacets are identically oriented, the incoming light creates a strong specular highlight in the reflected light. Conversely, if microfacets have a wide distribution of orientations, the light is reflected in many different directions, thereby creating a more diffuse light reflection.

As described above, roughness is a physical parameter of a surface that influences the physical gloss of the surface. Changes in physical gloss produce in turn a change in perceived surface appearance, i.e. how humans perceive the change of physical characteristics, such as perceived gloss.

Gloss is an important aspect of material surface appearance, and in particular surface reflectivity. Specular reflections are mirror-like reflections in a particular direction and gloss is the property that relates to that type of reflection. Physical gloss is measured in Gloss Units (GU). Gloss units are defined relative to the reflection of polished black glass with a refractive index of 1.567 (compared to air's refractive index of 1.000293), measured at 60° to the surface normal. The polished black glass standard is given the value of 100 GU. Gloss meters measure the amount of specular reflected light, by determining the ratio of light reflected at an opposite angle to the incident light. The opposite angle and an angle of incident light are defined by the ISO standard 2813 “Paint and varnishes—Determination of gloss values at 20°, 60° and 85° ” and ISO standard 7668 “Anodized aluminium and aluminium alloys—Measurement of specular reflectance and specular gloss at angles of 20°, 45°, 60° or 85°”. The opposite angle refers to an angle opposite to an angle of incident light with relative to the normal of the surface. For example if incident light is 30 degrees relative to the normal, then the measuring device is positioned at 30 degrees on the opposite side of the normal.

The concept of “physical gloss” can be distinguished from the concept of “perceived gloss or glossiness”. Physical gloss is measurable in physical objects, or determined entirely by the BRDF of the material in a rendering system. Perceived gloss or glossiness is a perceptual interpretation of a material, and may depend on other factors including the viewing conditions, mesoscale structure of the material, and the viewer themselves. As described below, roughness (specular roughness) is a physical parameter of a surface that influences the physical gloss of the surface. Changes in physical gloss produce in turn a change in perceived surface appearance, i.e. how humans perceive the change of physical characteristics, such as perceived gloss. As such, perceived gloss or glossiness is the perceptual response of the human visual system processing the light information related to physical gloss coming from the object's surface. Specular roughness is found to be negatively correlated with perceived glossiness for a wide range of mesoscale relief heights. Perceived glossiness is also affected by the mesoscale relief height of the surface. Perceived glossiness can be affected by viewing conditions, including the macroscale surface orientation relative to the viewing angle and light source. For example, perceived glossiness can be lower for surfaces with lower relief heights that are more frontally than obliquely oriented relative to the light source. In a typical scenario where a user designs the surface of an object, the user wants to set the parameters of the surface so as to obtain a desired surface appearance for a typical viewing angle set by the usage of the object. The user will therefore set the parameters of the material to achieve a desired appearance for a particular macroscale surface orientation relative to the viewing angle and light source.

It is known from scientific literature that a non-linear relationship exists between physical level of gloss and human perception of gloss. Perceived gloss or glossiness is the perceptual response of the human visual system processing the light information related to physical gloss coming from the object's surface. Perceived gloss is related to the capability of the human visual system to distinguish between diffuse and specular light information coming from the surface, and the interpretation by the human visual system of the information related to these two components. This interpretation depends for example on the sharpness of specular reflections. For visual design of an object and the object's surface appearance, perceived gloss is more important than the physical value of gloss in GU. A simple measure of physical gloss cannot fully describe the different perceptual aspects of gloss, such as specular gloss, contrast gloss or distinctness of gloss as defined in the literature.

Furthermore, perceived gloss can be predicted from information of specular highlights. Specular coverage of a surface refers to the proportion of a surface that appears to be covered by specular reflections.

Perception of colour is determined to be dependent on perceived gloss, which in turn is influenced by physical gloss. Furthermore, there is also a dependency between the perception of gloss and colour. For instance, known subjective studies have shown that perceived gloss changes depending on object colour, whereby brighter colours are perceived as less glossy than darker colours.

Additionally, perceived gloss (or glossiness) has been observed in known studies to affect the perceived lightness and colour saturation of objects.

Furthermore, there is an interaction between specular roughness and mesoscale height on the perception of gloss.

An existing method, involves classifying the pixels of an image of a surface into diffuse or specular highlight pixels, using the luminance information. These specular image regions are identified (i.e., segmented) using an image intensity histogram by assuming that all intensities above a fixed threshold relative to the mean luminance (50% above the mean luminance) can be classified as specular highlights. In a related known method, a fixed threshold dependent on a standard deviation of the luminance is used (such as twice the standard deviation of the luminance above the mean luminance). The drawback of this the photometric approach using a fixed threshold is that the approach can potentially generate poor classification of specular highlight pixels as the approach cannot disambiguate bright matte surface from specular reflection. For example, a surface with predominantly specular highlights would produce a high mean luminance value. Therefore, the histogram segmentation would tend to not classify the corresponding pixels as specular pixels as their luminance would fall below the determined threshold based on mean luminance. The histogram segmentation model cannot account for perceived coverage in a broad class of surfaces and viewing conditions. Surfaces with low relief height tilted to generate large glancing specular reflections can appear very shiny or glossy, but the surfaces can be completely overlooked by purely photometric models based on the statistical distribution of luminance values alone. The known method also does not account for the joint-variation of specular (micro-scale) roughness and mesoscale geometry, as the selection of the threshold value is highly dependent on the specular roughness and mesoscale structure. Accordingly, a specific threshold value does not provide accurate classification across various values of specular roughness and changing mesoscale geometry.

Perceived gloss is dependent on a range of image properties, including specular contrast, sharpness and coverage. The perceived gloss can be expressed as a weighted linear combination of specular contrast, sharpness and coverage. The parameters of specular contrast, sharpness and coverage can be subjectively measured using time-consuming psychophysical experiments.

Alternatively, perceived gloss can be determined from various statistics of specular content such as the percentage area, strength, average size, number and spread of the specular highlights. Perceived gloss is expressed as a linear combination of the derived statistics values.

As described above, perceived colour of a surface of a 3D object is influenced by gloss and specular highlights in the lighting and viewing conditions. It is therefore necessary to perform adjustment of colour in an editing tool by taking into account these aspects.

Methods to determine perceived gloss of a surface are known. However, the known methods rely on accurately segmenting the image of the surface into specular and non-specular content. As described above, the determination of specular content from an image of a surface is still technically a challenge.

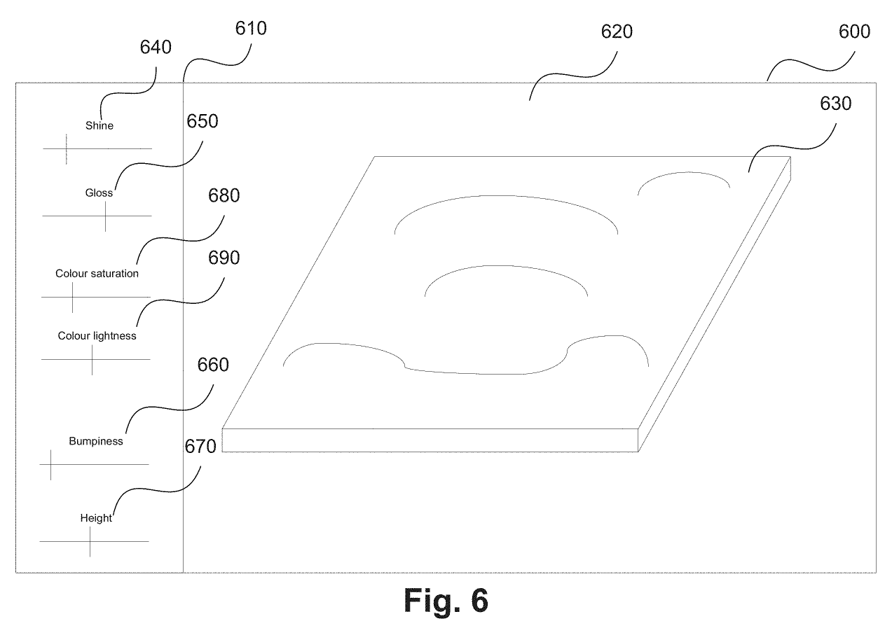

FIG. 6 shows an image 600. The image 600 represents a screenshot of an example user graphical user interface (GUI) 610 reproduced on the display 114. The GUI 610 is reproduced, for example on the display 114, by execution of the application 133 on the processor 105. FIG. 6 shows examples of elements of the user interface 610 for modifying the appearance of a material.

In a centre window 620 of the interface 610 is a rendering 630 of an object formed of the material. On the left of the interface 610 are controls 640, 650, 660, 670, 680 and 690 for modifying the appearance of the material. The controls 640 and 650 are used to modify the reflective properties (shine and gloss) of the material. The controls 660 and 670 (bumpiness and height) are used to modify the physical shape (also referred to as geometry) of the material at a mesoscale. The controls 680 and 690 (colour saturation and colour lightness) are used to modify the colour of the material. The object 630 shown in the window 620 is a 2.5D object. A 2.5D object in the context of the arrangements described represents substantially flat object at the macroscale with mesoscale variations in height. The object 630 is predominantly a 2D flat, square shape, but with some relief height added, as influenced by the controls 660 and 670.

The controls 640, 650, 660, 670, 680 and 690 are preferably presented as sliders, as shown in FIG. 6. In other arrangements, other control mechanisms such as dials, buttons and the like, can be used. The controls 660 and 670 relate to mesoscale structure bumpiness and height respectively. Bumpiness can relate to spatial frequency of the texture of the surface. In other arrangements additional controls for mesoscale structures such as frequency and flatness can be included in the GUI 610.

The controls 640 and 650 are for the physical parameters gloss and shine, and relate to perceptual appearance characteristics glossiness and shininess. In other arrangements additional or alternative controls can be included for other characteristics such as sparkle, grunge and the like.

The controls 680 and 690 relate to the perceptual appearance of colour saturation and lightness, respectively. In other arrangements additional or alternative controls can include colour hue or other colour descriptors. In the context of the arrangements described, perceptual appearance relates to a visual appearance observed by a human viewer or user.

The values of the parameters of controls 640, 650, 660, 670, 680 and 690 are stored in memory of the computer system. Each parameter is stored as a texture map, where each texture map contains a 2D array of local values (i.e. one value per pixel) for that parameter. Alternatively, if the value of the parameter is identical for all pixels, then the value is stored as a single global numerical value. When a parameter is modified, the corresponding texture map or numerical global value stored in memory is modified accordingly to the arrangements described. For example, when surface geometry is modified using the control 670, an updated colour saturation and colour lightness are determined and adjusted according to the arrangements described. Subsequently, the corresponding texture maps (or global value) of the colour saturation and lightness parameters are modified and are stored again in memory.

FIG. 4 shows a method 400 of rendering a graphical object according to one of the arrangements described. The method 400 is typically implemented as one or more modules of the application 133 stored in the memory 106, and controlled by execution of the processor 105.

The method 400 is performed in response to the user modifying a user interface control that impacts the perceived material appearance of the object. The method 400 starts when a graphical object is reproduced for the user to view via an interface, such as the GUI 610.

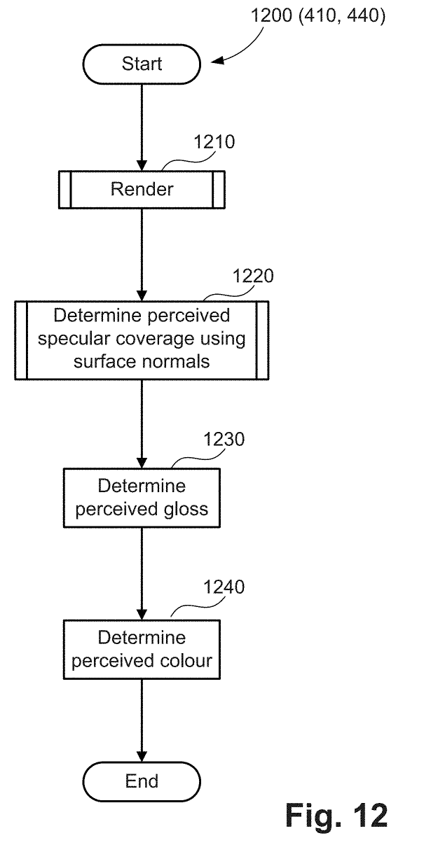

The method 400 starts at a measuring step 410. At step 410, the initial perceived colour of the surface of the object is determined or measured using initial information about the material appearance parameters 402 and an initial surface geometry 405 of the object. The initial perceived colour of the surface can include initial perceived colour saturation and/or initial perceived colour lightness. Operation of step 410 is described in relation to a method 1200 in FIG. 12 hereafter.

The initial information about material appearance parameters 402 is obtained for example from initial values imported into the application 133, from the values of the controls 640, 650, 660, 670, 680, 690, or from any application-related method assigning initial values assigned to the parameters. The initial surface geometry 405 is typically readily available from the 3D mesh imported in the application module or can be obtained by determining the orientation of surface normals of the faces of the 3D mesh. The output of step 410 is an initial measure of perceived colour of the surface of the object.

The method 400 continues under execution of the processor 105 from step 410 to an adjusting step 420. At step 420, an adjustment or modification to the perceived material appearance, such as perceived gloss, perceived colour, is made. The arrangements described relate to receiving an input modifying an appearance parameter relevant to gloss, such as specular roughness, mesoscale height, bumpiness or gloss. As described above, different parameters of a surface can be modified to affect perceived material appearance, such as a modification of the physical gloss or a modification of the surface geometry. For example, the modification is received from a user interacting with controls (such as the controls 650, 660 and 670) of a user interface (such as the interface 610). The application 133 receives a signal indicating the modification in structure via the GUI 610, for example via the user manipulating the mouse 103.

As described above, mesoscale and microscale geometry variations both influence the perceived gloss and colour of a surface. Objects in computer graphics rendering software are represented in the form of a 3D mesh of polygons on which a surface texture is applied. In the implementation described, modification of material appearance relates to a modification of the surface geometry (e.g. mesoscale height) using for example controls 660 and 670. However, the arrangements described are not limited to this method of modifying a surface geometry and may be used for any other method of modifying surface geometry. In another implementation, modification of material appearance relates to modification of a light scattering parameter affecting the reflectance of the surface, such as modification of specular roughness. Execution of step 420 produces a change or modification of the value of the selected material appearance parameter, providing an updated value 425 of the material appearance parameter.

Following adjustment of a parameter affecting perceived material appearance at step 420, the method progresses to an updating step 430. At step 430, the 3D mesh of the object is updated. In execution of step 430, the mesh representation of the graphical object (such as the object 630) is updated according to the new, adjusted mesoscale geometry. New values for vertex attributes, such as positions, are determined according to the values provided by the controls 660 and 670. For example, in a case of height scaling provided by control 670, the value of the vertical coordinate of the vertex is simply multiplied by the scaling factor provided by the user. The output of execution of step 430 is an updated surface geometry 435.

The method 400 progresses under control of the processor 105 from step 430 to a measuring step 440. At step 440, an updated measure of perceived colour is determined using the updated material appearance parameter 425 determined at step 420 and the updated surface geometry 435 determined at step 430. Step 440 uses the same method as step 410 to determine perceived colour, and operates in the manner of the method 1200 of FIG. 12. The output of step 440 is an updated measure of perceived colour.

The method 400 progresses under control of the processor 105 from step 440 to an updating step 450. Step 450 operates to adjust colour properties of the surface to maintain perceived colour properties and to update perceived gloss based on the modification received at step 420. The adjustment is based on the perceived specular coverage and resultant perceived gloss and colour appearance determined at step 440. Using the initial perceived colour determined at step 410 and the updated perceived colour determined at step 440, step 450 adjusts the diffuse colour of the surface to maintain the initial perceived colour. In one implementation, a ratio R of the updated perceived colour to the initial perceived colour is determined. The initial diffuse colour saturation is then compensated by multiplying the initial value by the inverse of R. For example, if the updated perceived colour saturation value has reduced by 20% compared with the initial value, then the diffuse colour saturation is increased by 20% to compensate for the effect of perceived gloss and coverage on the perceived colour saturation. In another implementation, the adjusted diffuse colour saturation is a polynomial function of the parameters used to modify the initial appearance, where the coefficients of the polynomial function are obtained from psychophysical experiment data. In another implementation, the adjusted diffuse colour saturation is determined from a look-up-table obtained from psychophysical data. For example, a look-up-table represents a direct mapping between a perceived colour saturation and a set of input material appearance parameters (e.g. colour, gloss) values or range of values. In a preferred implementation, colour values and colour-related computations are performed in a perceptually linear space such as CIE LCH or CIE Lab space. In one arrangement, the control 680 is automatically adjusted to reflect this change of value in response to a user input changing the material appearance parameters such as 640, 650, 660 or 670.

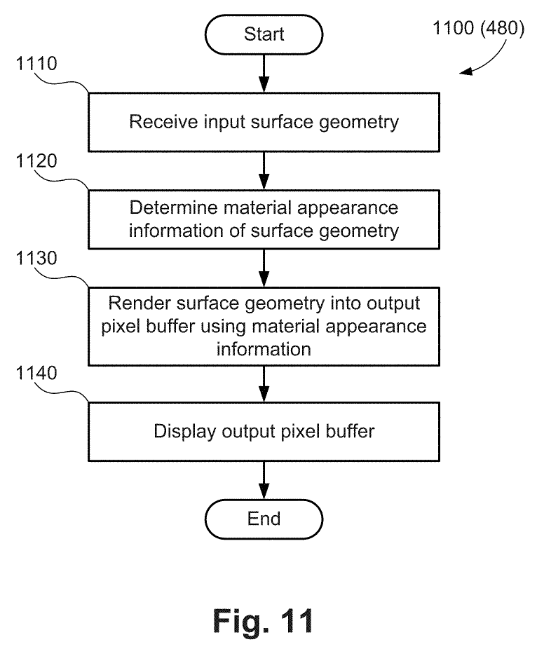

As shown in the example of FIG. 4, the method 400 progresses under control of the processor 105 from step 450 to a rendering step 480. At step 480, the surface colour is rendered using updated colour information determined at step 450, the updated mesh 435 and the material appearance parameters such as provided via the controls 640, 650, 660 or 670. At step 480, the updated pixels values are rendered and displayed in the user interface. Operation of step 480 is described hereafter in relation to a method 1100 shown in FIG. 11.

In another arrangement, after execution of step 450, the method 400 returns to step 440, as shown in a dashed line to determine a new updated measure of perceived colour according to the updated value of diffuse colour determined at step 450. The method 400 iterates between step 450 and step 440 until pre-determined criteria is satisfied. For example, a ratio R of the updated perceived colour to the initial colour is determined at step 450 of each iteration, and the return loop from step 450 to step 440 stops when R stops changing or the change of R value is below a pre-determined threshold (such as for example 0.01). The threshold may be determined by experimentation for example. In another embodiment, the iteration from step 450 to step 440 stops when the R value is equal to 1 to within a pre-determined threshold such as 0.01. The initial diffuse colour saturation is then compensated by multiplying the initial value by the inverse of the final value of R obtained at the last iteration. The method 400 then proceeds to step 480.

The method 400 ends after execution of step 480.

FIG. 12 shows the method 1200 of determining perceived colour saturation and lightness, as executed at steps 410 and 440 of the method 400. The method 1200 is typically implemented as one or more modules of the application 133 stored in the memory 106, and controlled by execution of the processor 105.

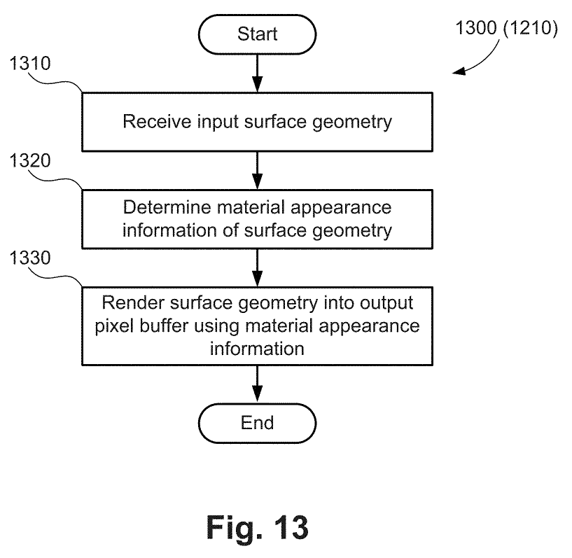

The method 1200 starts at an intermediate rendering step 1210. The step 1210 executes to render internally pixel values of the surface in order to determine perceived colour. The rendered pixel values are not displayed to the user in the window 620 of the user interface 610. Operation of step 1210 is described in more details hereafter as a method 1300 shown in FIG. 13.

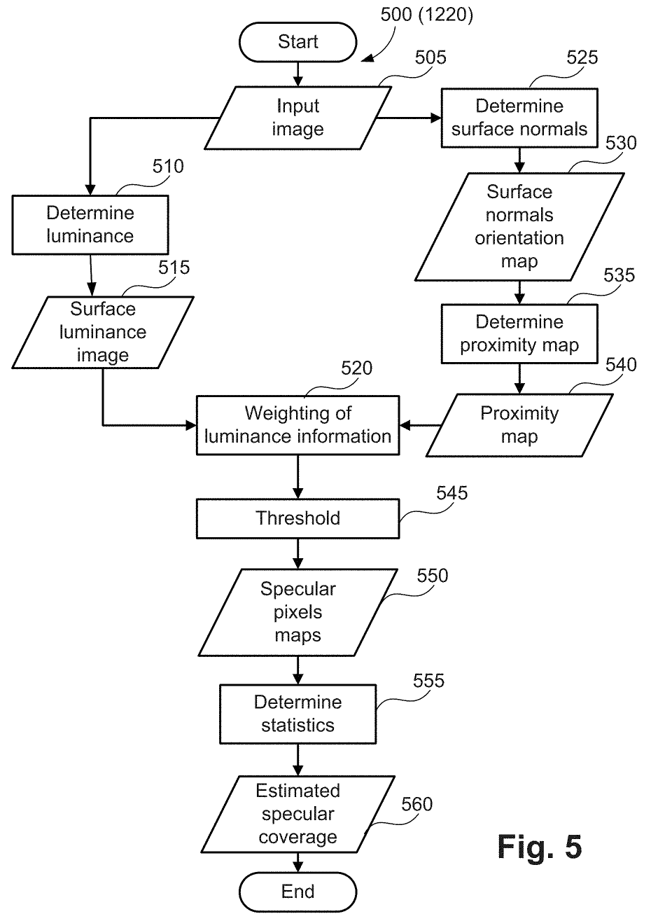

The method 1200 proceeds under execution of the processor 105 from step 1210 to a determining step 1220. At step 1220, a measure of perceived specular highlight coverage is determined using the received surface geometry information, that is the mesh, and the rendered pixels determined in step 1210. Perceived specular highlight coverage (also referred to as perceived specular coverage) relates to a model of how a human viewer would perceive coverage of a surface by specular highlights rather than actual physical specular coverage, as determined using psychophysical trials. Perceived specular coverage is determined relative to a zenith (z-axis) angle in the arrangements described, whereas physical specular coverage is in contrast measured from a specular angle. Operation of step 1220 is described in greater detail in relation to a method 500 shown in FIG. 5.

In a preferred arrangement, the method 1200 proceeds under control of the processor 105 from step 1220 to a determining step 1230. At step 1230, perceived gloss of the surface of the object is determined. Perceived gloss is predicted or determined from characteristics of the surface. To this effect, a model of perceived gloss expresses a relationship between physical attributes or perceptual attributes of the surface and the perceived gloss. Existing approaches to determine perceived gloss using information of specular highlights can be used at step 1230 here.

One example of determining perceived gloss is described herein. After specular pixels are identified in execution of step 1220, specular pixels can be grouped into connected areas of specular content using an 8-nearest neighbourhood connection. Specular pixels are connected into a single specular area if edges or corners of the specular pixels touch, such that adjoining pixels are part of the same connected area if they are connected along the horizontal, vertical or diagonal direction. Once connected areas of specular pixels are determined, statistics of specular content can be derived, such as the number, average size, strength, and spread of the specular highlights. The number of specular pixels is determined to be the total number of connected areas. The size of a connected area is determined to be the number of pixels of that connected area. The total size of all connected areas can be determined as the sum of the size of each connected area.

Alternatively, the size can be expressed as a percentage relative to the total number of pixels of the surface. Average size is determined to be the mean size of connected areas. Strength is determined to be the mean pixel intensity value of the connected areas. Spread is determined to be the standard deviation of the size of connected areas. The perceived gloss is expressed as a linear combination of the determined statistics. Furthermore, perceived specular coverage determined at step 1220 is advantageously one of the statistics included in the linear combination to compute perceived gloss.

The method 1200 proceeds under control of the processor 105 from step 1230 to a determining step 1240. Execution of step 1240 determines a value of perceived colour. Colour can be expressed in various colour spaces. In one arrangement of the method, colour is expressed in the HSV colour space, where H represents the hue, S represents the saturation and V represents the value of the colour. Psychophysical tests indicate that perceived gloss decreases with increasing specular roughness (microscale roughness) for a wide range of relief heights, except for very low relief height (relatively flat) surfaces with a near frontal view. Psychophysical tests also indicate that perceived colour value increases with increasing specular roughness, whilst perceived colour saturation decreases with increasing specular roughness. According to one arrangement, the perceived colour saturation is expressed as a function of perceived gloss and perceived coverage using the relationship of Equation (1):

Pcoloursaturation=w*Pcoverage+(1−w)*(1−Pgloss) (1)

According to Equation (1), perceived colour saturation Pcoloursaturation is determined as a weighted linear combination of perceived specular coverage Pcoverage and perceived gloss Pgloss. Perceived specular coverage of a surface refers to the proportion of a surface that appears to be covered by specular reflections. Equation (1) effectively expresses a model of perceived colour saturation. Weight w is determined by fitting Equation (1) to psychophysical data obtained through experiments. In one embodiment, different values of the weight w can be determined for different orientations of the surface relative to the viewing direction. For example, for a slant angle orientation of 15, 30 and 45 degrees, w=0.46, 0.67 and 0.42, respectively. In one arrangement, different values of the weight w are used for different colour hues. For example, the weight values described above can be assigned to ‘blue’ hue, and the following weight values of w=0.62, 0.86, 0.7 can be assigned to ‘red’ hue for a slant angle orientation of 15, 30 and 45 degrees, respectively. The weight values for other colour hues may be determined using psychophysical experiments.

The previously described method to determine perceived colour saturation also applies to computation of perceived colour value, as shown in Equation (2).

Pcolourvalue=w*Pcoverage+(1−w)*(1−Pgloss) (2)

According to Equation (2), perceived colour lightness Pcolourvalue is determined as a weighted linear combination of perceived specular coverage Pcoverage and perceived gloss Pgloss. Weight w is determined by fitting Equation (2) to psychophysical data obtained through experiments. In one embodiment, different values of the weight w can be determined for different orientations of the surface relative to the viewing direction. For example, for a slant angle orientation of 15, 30 and 45 degrees, w=0.81, 0.35 and 0.45, respectively. In another arrangement, different values of the weight w are used for different colour hues. For example, the weight values described above can be assigned to ‘blue’ hue, and the following weight values of w=0.47, 0, 0.26 can be assigned to ‘red’ hue for a slant angle orientation of 15, 30 and 45 degrees, respectively. The weight values for other colour hues may be determined using psychophysical experiments.

The weights w determined in Equations (1) and (2) can vary with macroscale surface orientation, i.e. the dependence of perceived colour saturation or colour value on perceived coverage varies as a function of proximity of the macroscale surface's orientation relative to the primary lighting direction. In one arrangement of the method, the weight for a given colour is determined from averaging psychophysical data obtained over different macroscale surface orientations for that colour. In another arrangement of the method, the weight for a given colour is determined from psychophysical data obtained for a specific macroscale surface orientation for that colour. In yet another arrangement of the method, the weight w is determined to be higher for surfaces with orientation tending more towards the primary light source (i.e. macroscale surface normals align more with light direction) and lower for surfaces with orientation tending more away from the primary light source (i.e. macroscale surface normals are more orthogonal to the light direction). Accordingly, the dependence of perceived colour (chroma or saturation, lightness or value) on perceived coverage increases as a function of proximity of the surface's orientation relative to the primary lighting direction.

In another arrangement of the method, the colour is expressed in another colour space, such as CIE LCH, where L represents colour lightness, C represents colour chroma and H represents colour hue. The weights w in Equations (1) and (2) are determined from transforming the psychophysical data to the CIE LCH colour space. Equations (1) and (2) determine Pcolousaturation and Pcolourvalue, respectively, where Pcoloursaturation is the computed perceived colour saturation and Pcolourvalue is the computed perceived colour value.

In another implementation, perceived colour saturation and perceived colour value are determined at step 1240 directly from statistics of specular content determined at step 1220, such that the step 1230 is excluded. In the case where step 1230 is excluded, Equations (1) and (2) express perceived colour saturation and perceived colour value, respectively, as a function of specular coverage or statistics of specular content such as the number, average size, strength, and spread of the specular highlights. Perceived colour saturation and perceived colour value are therefore expressed as a linear combination of the statistics determined at step 1220. In another implementation where colour is expressed in another colour space such as CIE LCH, perceived colour chroma and colour lightness are determined at step 1240 directly from statistics of specular content determined at step 1220, such that the step 1230 is excluded. Equations (1) and (2) express perceived colour chroma and perceived colour lightness, respectively, as a function of specular coverage or statistics of specular content such as the number, average size, strength, and spread of the specular highlights. Perceived colour chroma and perceived colour lightness are therefore expressed as a linear combination of the statistics determined at step 1220.

The method 1200 ends after step 1240 and results in a value of perceived colour.

A method of obtaining psychophysical data, as used in step 1240, is now described. Given a high level perceptual appearance characteristic, such as perceived colour, perceived gloss, perceived coverage, and a set of properties which may influence the perceptual appearance characteristic, an experiment can be designed. In the experiment, the observers are shown a set of stimuli. Each stimulus is a material rendered according to a particular combination of parameters, such as specular roughness, mesoscale height, bumpiness texture, surface orientation, and colour. The choice of parameters is guided by each parameter's possible influence on the perceptual appearance characteristic. The combinations of parameters should be such that the parameters sufficiently cover the range of values which could be taken by the set of influencing properties.

The user provides a response for each stimulus based on the user's observation of the stimulus. A number of methods of providing a response can be used. For example, the user can provide a rating on a scale for the perceptual appearance characteristic. For example, the user may be asked “How glossy does this material appear?” and choose a number from 0 to 10. Alternatively, the user may be asked to modify another material to match the stimulus, such as adjusting the colour of another material until the material matches what the user perceives to be the colour of the stimulus. Another alternative is to ask the user to compare pairs of stimuli and decide which has the perceptual appearance characteristic more strongly, for example the user can be asked “Which material is more glossy?” or “Which material shows more specular coverage?”. The choice of response type is based on the difficulty of the task for the user (generally comparing is easier, while rating and matching are more difficult) and the usefulness of the resulting data (generally comparisons are less useful while matching and rating are more useful). Next, the results are gathered for all users. The users' responses are converted to scale values, using a method appropriate to the type of response given. A model is constructed by fitting a mathematical function between the stimulus values and the observed responses. The method is used to determine the values of w in Equations (1) and (2).

FIG. 11 shows method 1100 of rendering an input surface geometry to an output pixel buffer, as implemented at step 480 of FIG. 4. The method 1100 is typically implemented as one or more modules of the application 133, stored in the memory 106 and controlled under execution of the processor 105.

The method 1100 begins at a receiving step 1110. The step 1110 receives an input geometry, such as an updated geometry obtained from step 430.

The method 1100 proceeds under control of the processor 105 from step 1110 to a determining step 1120. In execution of step 1120, the material appearance information of the surface geometry is determined by referring to a set of texture maps associated with the updated mesh, where each texture map contains a 2D array of values for one material appearance parameter. Material appearance parameters include diffuse colour, hue, saturation or reflectance, or gloss or microscale roughness. One or several of these texture maps can be used to define the surface appearance of the material. For example, a 2D texture map representing the diffuse colour of the surface contains the numerical RGB values for each pixel. In an alternative representation of the colour dimensions, a texture map contains the hue values for each pixel, while another texture map contains the saturation values for each pixel. In yet another example of texture maps, microscale roughness can be represented as a 2D array of numerical values on an arbitrary scale representing an amount of roughness of the surface at each pixel location. The texture maps are used to look up the material appearance parameters for each location on the mesh. The surface geometry is provided by the updated mesh 430.

The method 1100 proceeds under control of the processor 105 from step 1120 to a rendering step 1130. In execution of the step 1130, the surface geometry is rendered into an output pixel buffer, using the material appearance information. Rendering at step 1130 involves rasterizing the polygons in the mesh that are visible to the viewing direction using material appearance information for each polygon and the associated interaction with the lighting environment. Another example method of rendering that can be used at step 1130 is ray-tracing. The method 1100 proceeds under control of the processor 105 from step 113 to a display step 1140. In execution of the step 1140 the output pixel buffer is displayed, for example via a GUI reproduced on the display 114. After step 1140, the method 1100 ends.

FIG. 13 shows the method 1300 of rendering an input surface geometry, as implemented at step 1210 of FIG. 12. The rendered pixels generated in execution of the method 1300 are not displayed to the user interface but are used for calculations using values related to rendered pixels. The method 1300 is typically implemented as one or more modules of the application 133, stored in the memory 106 and controlled under execution of the processor 105.

The method 1300 begins at a receiving step 1310. The step 1310 operates to receive an input geometry, such as the updated geometry obtained from step 430. The method 1300 then proceeds under control of the processor 105 from step 1310 to a determining step 1320. In execution of step 1320, the material appearance information of the surface geometry is determined by referring to a set of texture maps associated with the updated mesh, where each texture map contains a 2D array of values for one material appearance parameter. Material appearance parameters include diffuse colour hue, saturation, or reflectance, or gloss or microscale roughness. The texture maps are used to look up the material appearance parameters for each location on the mesh.

The method 1300 proceeds under control of the processor 105 from step 1320 to a rendering step 1330. In execution of the step 1130, the surface geometry is rendered into an output pixel buffer, using the material appearance information. After step 1330, the method ends.

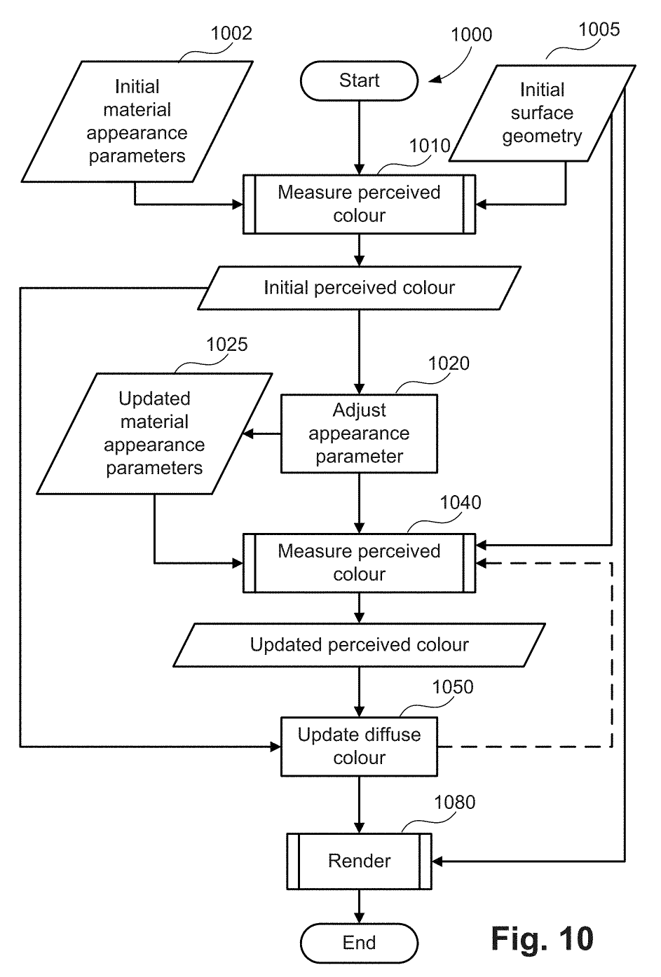

FIG. 10 shows a method 1000 of rendering a graphical object according to another embodiment. In the arrangement of FIG. 10, the received modification to the perceived material appearance relates for example to a modification of specular roughness, using the control 650. In this case, the user adjusts a parameter which does not change the surface geometry. The method 1000 is typically implemented as one or more modules of the application 133 stored in the memory 106, and controlled by execution of the processor 105.

Objects in computer graphics rendering software are typically represented in the form of a 3D mesh of polygons on which a surface texture is applied. Modification of the specular roughness does not modify the geometry of the surface but only affects the light scattering behaviour of the surface, which affects perceived gloss and perceived colour. The specular roughness may be modified by modifying a corresponding specular roughness texture map.

The method 1000 includes steps 1010, 1020, 1040 1050 and 1080 which operate in the same manner as steps 410, 420, 440, 450, and 480, respectively.

At step 1010, the initial perceived colour of the surface of the object is determined using the initial information about material appearance parameters 1002 (similar to 402) and an initial surface geometry 1005 (similar to 405) of the object. Step 1010 is implemented as described in relation to the method 1200 of FIG. 12. The output of step 1010 is an initial measure of perceived colour of the surface of the object.

Method 1000 progresses from step 1010 to step 1020. At step 1020, an adjustment to the perceived material appearance is made. Step 1020 produces an updated value 1025 (similar to the value 425) of the particular material appearance parameter. The modification is typically determined by a user interacting with controls (such as the control 650) of a user interface (such as the interface 610). The application 133 receives a signal indicating the modification in specular roughness via the GUI 610.

Following adjustment of a parameter affecting perceived material appearance at step 1020, the method 1000 progresses to step 1040. At step 1040, an updated measure of perceived colour is determined using updated material appearance parameters from step 1020 and the surface geometry information 1005. Step 1040 of determining perceived colour uses the same method as step 1010. The output of step 1040 is an updated measure of perceived colour.

The method 1000 progresses from step 1040 to step 1050. Using the initial perceived colour determined at step 1010 and the updated perceived colour saturation determined at step 1040, step 1050 adjusts the diffuse colour of the surface to maintain the initial perceived colour as described in relation to step 450.

In one arrangement, the method 1000 progresses from step 1050 to step 1080. At step 1080, the surface colour is rendered using the information of the adjusted colour saturation. At step 1080, the updated pixels values are rendered and displayed in the user interface.

In another arrangement, after executing step 1050, the method 1000 returns to step 1040 (as shown in dashed lines) to determine a new updated measure of perceived colour according to the updated value of diffuse colour determined at step 1050. The method 1000 iterates between step 1050 and step 1040 until criteria is satisfied as described in relation to the method 400. The method 1000 then proceeds to step 480.

The method 1000 ends after executing step 480.

In yet an alternative arrangement, the rendering of a graphical object is performed upon receiving a modification of geometry, and with the method determining the adjustment of the specular roughness parameter to maintain perceived colour. The steps of the method are identical to those in FIG. 4 until step 450. Using the initial perceived colour saturation determined at step 410 and the updated perceived colour saturation determined at step 440, step 450 determines the specular roughness to maintain initial perceived colour. In one arrangement, a ratio R of the updated perceived colour to the initial perceived colour is determined. The specular roughness has an inverse correlation with perceived saturation, i.e. perceived saturation tends to decrease as specular roughness increases. As such, the initial specular roughness is compensated by multiplying the initial value by R. In another embodiment, the adjusted specular roughness is a polynomial function of the parameters used to modify the initial appearance, where the coefficients of the polynomial function are obtained from psychophysical experiment data. In another embodiment, the adjusted specular roughness parameter is determined from a look-up-table obtained from psychophysical experiment data. For example, a look-up-table indicates a direct mapping between specular roughness and a set of input material appearance parameters (e.g. mesoscale height, bumpiness, colour).

The remaining steps of the method are identical to those in FIG. 4.

Step 1220, for determining perceived specular coverage, as depicted in FIG. 12, is further detailed below and in relation to FIG. 5.

As described previously, rendering an object on a GUI such as the GUI 610 involves considering geometric information about the distribution of luminance variations relative to 3D surface shape. In existing methods, the use of luminance information alone can lead to misclassifying specular areas into matte areas, and vice-versa. In the arrangements described, geometry information is advantageously used to overcome the limitations of using luminance information alone. Geometry and luminance information are jointly used to identify the pixels of the surface that are likely to produce a specular highlight. The arrangements described are applicable to all scenarios where geometry information of the surface is made available. For example, the method can be advantageously used in any rendering environment or 3D CAD tool, as full 3D model of the object is readily available and surface orientation can be determined directly from the 3D model, that is information is available concerning the orientation of surface normals relative to global scene coordinates or local coordinates described relative to the direction of the observer.

Although coordinates can be described in relation to the fixed location(s) of the light source(s), the precise locations of the light sources are typically not inferred perceptually by human observers. Instead, interpretation of surface geometry and lighting is generally based on a convexity bias and assumed lighting from above bias. An assumption can be made that the light source is situated directly above the scene. That is, the lighting direction is assumed to be aligned with the vertical (z) axis of the scene.

The method 500 of FIG. 5, as implemented at step 1220 of FIG. 12, starts with an input image 505 of the surface of the object. The method 500 is typically implemented as one or more modules of the application 133 stored in the memory 106, and controlled by execution of the processor 105.

In computer graphics rendering environments, orientations of normals are readily available to the user. In implementation, the orientations of normals of the surface of the object are determined at step 525 to create a normal orientation map. In a preferred implementation, step 525 determines the orientation of surface normals with respect to the vertical (z) zenith axis of the scene. FIG. 7 is referred to for the x, y and z axis orientations. 3D objects are represented as connected polygons such as triangles. The surface normal for a triangle can be determined by taking the vector cross product of two edges of that triangle. The angle of the component of the surface normal vector in the same plane as the y-z axes is calculated for each face of the mesh on a scale from −π/2 to π/2 radians, where π/2 indicates a normal pointing along the positive z-axis, 0 represents a normal angle pointing along the y-axis, and −π/2 represents a normal pointing along the negative z-axis. The determined angle for a face of the mesh is used as a normal orientation of the face. However, as will be appreciated by those skilled in the art that other, e.g. normalised, scales can be suitably used and that any other alternative method to compute determined represent surface normals orientation can be used.

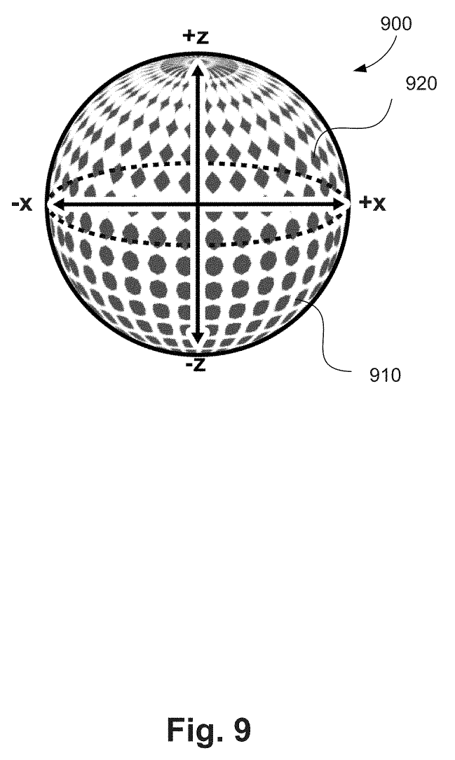

The orientation of the surface normals can be visualised for illustrative purposes, where the surface geometry from the perspective of the viewing direction (a camera's z-axis) is represented as shown for example in FIG. 9. FIG. 9 illustrates, for a 3D sphere 900, surface normal orientations using a pattern coding. In FIG. 9, surface normals pointing upward (+z) relative to the horizontal (x,y) plane are represented with diamond-shaped markers, such as a marker 920. Surface normals pointing downward (−z) relative to horizontal (x,y) plane are represented with octagon-shaped markers, such as a marker 910. The size of a marker varies and indicates how close the normal orientation is to the zenith axis at that point, i.e. the smaller the marker the closer the normal orientation is to the zenith orientation.

The method 500 progresses under control of the processor 105 from step 525 to a mapping step 535. Step 535 operates to determine a proximity map 540. At step 535, the values of the normals orientations map are linearly mapped to weighting coefficients values, e.g. represented as greyscale intensities. In a preferred arrangement, normal orientation values are mapped to a normalised [0,1] range, where 1 represents normals aligned in the same direction as the zenith direction (+z) and 0 represents normals aligned in the opposite direction of the zenith direction (−z). The proximity map therefore provides a greyscale image representation of the angle of the normal relative to the +z direction at a given location of the surface. By mapping normal orientation values to a normalised [0,1] range, step 535 effectively operates to determine a greyscale value or a weighting coefficient for each of the pixel values of the surface using a corresponding normal, viewing angle and a position of a light source using the relevant appearance parameters (for example the initial appearance parameters in step 410 or the modified appearance parameter in step 440).

The method 500 determines a surface luminance image 515 at step 510. In a preferred arrangement, the RGB colour information of the pixels of the input image are converted to a more perceptually linear space such as CIE LCH, where L represents the lightness of the colour. In one embodiment, the L component of the LCH colour representation of the image is used to express the values of the luminance map. Other known representations of luminance information in other colour spaces can also be used, such as the L component in CIE LAB.

The step 510 can be executed in parallel to the steps 525 and 535 as shown in FIG. 12. Alternatively the step 510 can be executed before, between or after the steps 525 and 535.

Once the surface luminance map 515 and proximity map 540 are determined, the method 500 progresses to step 520. The values in the proximity map 540 correspond to weighting coefficients for weighting pixel values in the luminance image 515 at step 520. At step 520, the proximity map 540 is used to weight the pixel values of the luminance map by performing a pixel-wise multiplication between the proximity map 540 and the surface luminance image 515.

The method 500 progresses from step 520 to a step 545. At step 545, a threshold operation is performed. The output of step 520 is a greyscale map. The values of the greyscale map are compared against a pre-determined threshold. For each value of the greyscale map, if the value is above the pre-determined threshold, the corresponding pixel is considered as a specular highlight pixel. Otherwise, the pixel is classified as a diffuse pixel. As such, the threshold operation produces a binary map indicating the pixels classified as specular highlight pixels and those classified as diffuse pixels, where “1” corresponds to specular highlight pixels and “0” corresponds to diffuse pixels. The result of the threshold operation is a map 550 of specular pixels. In one embodiment, the threshold is determined according to the surface reflectance properties, surface albedo (diffuse colour) and lighting environment information, which is readily available in computer graphics rendering tools. The threshold is determined to be a value that is close to the expected luminance maxima for the surface when rendered completely matte (after accounting for light intensity and surface reflectance). According to one embodiment, the threshold value is determined to be 0.55.

The method 500 progresses to step 555, which computes statistical values using the specular pixels maps. In a preferred embodiment of this invention, the number of specular highlight pixels is determined. Specular coverage 560 is subsequently computed as a percentage of highlight area by dividing the number of highlight pixels by the total number of pixels of the surface. Step 555 operates to determine perceived coverage of the surface by specular highlights based on the pixel values determined at step 520.

The method 500 ends after executing step 555.

The arrangements described are applicable to the computer and data processing industries and particularly for the graphics and 3D modelling industries.

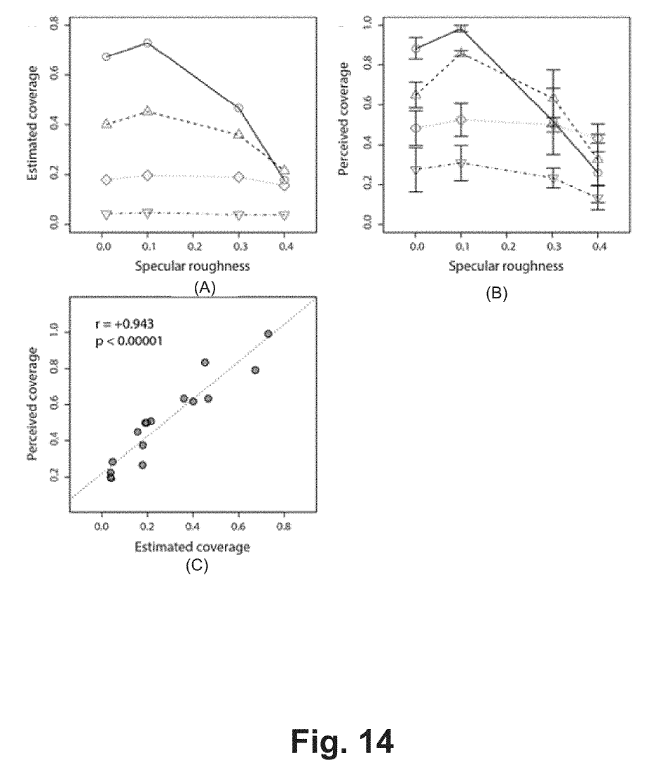

FIG. 14, which includes FIGS. 14A to 14C, illustrates a set of results of an implementation of the method 500. In FIG. 14, estimated specular highlight coverage is obtained for four different mesoscale relief heights of surfaces viewed at a slant of 45 degrees. FIG. 14A shows an automatically determined estimated coverage as a function of specular roughness with different relief heights: 0.025 (circles), 0.050 (upward triangles), 0.100 (diamonds), and 0.200 (downward triangles). FIG. 14B shows psychophysical measures of perceived coverage. The pattern of estimates in FIG. 14A closely resembles the psychophysical data obtained on perceived specular coverage in FIG. 14B. FIG. 14C shows a strong linear relationship (linear Pearson correlation coefficient r=0.943) between perceived and computed measures of specular highlight coverage as computed with method 500.

In adjusting the reflective properties of the material to maintain a perceived visual characteristic such as glossiness, the arrangements described allow a graphical interface such as the interface 610 to include controls relating to high level concepts, easily understood by users that are not graphics experts. The arrangements described further allow the user to focus more on higher level or perceptual concepts rather than on complex relationship between many low-level or physical parameters. Typically, existing 3D editing software does not provide an intuitive user interface which enables the user to understand effects of physical parameters on material appearance, thus effectively relying on the user's expertise. The described arrangements effectively shelter the user from the complex relationship between the preserved perceptual characteristics and the physical reflective properties of the material. Instead, the complex relationship is handled via the perceptual model to preserve the user's desired or intended visual effect. The user can accordingly achieve a desired effect in a shorter time with reduced manual adjustment of properties compared to previous solutions.

A complete example using arrangements described is provided hereafter.

The methods described can advantageously be used to ensure that the perceived colour of an object is as intended by the designer (user). A user wants to design a 3D object with a specific colour appearance representing the identity of a brand, over a wide range of objects having different light reflectance properties such as a handbag with leather texture, and a book cover for a product brochure for example. The handbag and book cover objects have various mesoscale textures and macroscale shapes, and different surface light reflectance characteristics but the user wants the colour to appear the same on all objects. As described above, setting a specific diffuse RGB colour can produce different perceived colours across the objects. The arrangements described address this limitation. As an object designer, the user has access to a 3D mesh representation of the object. Alternatively, the user can use a 3D scanner to scan a physical object and import the 3D digital scan into software for viewing and editing (for example using the interface 610).

The user can edit the properties of the surface of the object using the 3D editing software and the user interface 610. For example, the user can set a specific colour look for the handbag by setting a physical colour and for a given texture relief of the object. The user then decides to create another handbag that has a texture with a different mesoscale relief. In designing the texture of the new handbag for example, the user chooses to modify the texture of the handbag by adjusting the mesoscale relief of the surface using the controls 660 and 670. The method 400 executes to determine the resulting perceived colour saturation from the modified parameters and automatically adjusts the diffuse colour initially set by the user so that the perceived colour is maintained identical to the initial handbag design. The user may then decide to create a third handbag that has the same texture relief but with a glossier look of the material, by adjusting the specular roughness using control 650. The adjustment results in a new determination of the perceived colour saturation of the surface using the method 400, and the editing software 133 automatically adjusts the diffuse colour saturation to match the perceived colour of the second handbag.

The methods described can advantageously be used to transfer the perceived colour of one object to another one. If the colour look is important to the designer (user), maintaining the same perceived colour is important. The user wants to design a product brochure showcasing a handbag such that the cover page appears to have the same colour as one of the handbags. The cover of the book may also have a texture mimicking the texture of the handbag for realistic look and feel matching the handbag. The paper used for the brochure has a certain roughness and thickness that influences the light scattering from the surface of the paper. The user can modify the specular roughness of the brochure cover page in the editing software and preview the appearance. By setting a new specular roughness value, the method 1000 executes to determine the resulting perceived colour and adjusts the diffuse colour for the print so that the perceived colour of the print matches the perceived colour of the handbag.

In another example, the user wants to design different objects with the intent of having a specific perceived colour that is similar across the different objects. As described above, the user can initially set various material appearance parameters, including diffuse colour, specular roughness, for the initial object having a given surface geometry. Subsequently, the user wants to design an object with a different surface geometry but wants to maintain the same perceived diffuse colour. As described above, modifying the surface geometry may impact the perceived colour. The methods described herein can advantageously be used to determine how light scattering parameters, such as specular roughness, need to be adjusted so that the perceived colour of the initial object is maintained in the design of the second object.

In yet another example, the arrangements described are used to evaluate the difference of perceived colour saturation between different designs of an object having variation of either surface geometry or light scattering parameters, or both. In the example, the user designs a first object by setting various material appearance parameters, including diffuse colour, specular roughness, for the object having a given surface geometry. Subsequently, the user designs a second object with one or several modifications of diffuse colour, light scattering, and surface geometry. The methods described can be used to determine the resulting perceived colour saturation for the second object and quantify the difference in perceived colour saturation between the two objects. The information on the perceived colour difference can allow a user to make a quantitatively informed decision. For example, the user may decide that the perceived colour difference is small enough and does not require further design changes. In some other cases, minimum perceived colour difference is required and the measurement allows the user to understand the constraints of the design to maintain perceived colour. The difference of perceived colour saturation can be provided to the user with various methods. For example, a numerical scale of perceived difference is used. In another example, a visual feedback such as a warning icon is presented to the user on the graphical interface when the difference of perceived colour is above a threshold that can be set by the user.

The foregoing describes only some embodiments of the present invention, and modifications and/or changes can be made thereto without departing from the scope and spirit of the invention, the embodiments being illustrative and not restrictive.

1. A method of rendering an image of a surface, the method comprising:
receiving a user input modifying a material appearance parameter of the surface related to perceived gloss;
determining a weighting coefficient for each of a plurality of pixel values of the surface using a corresponding normal, viewing angle and a position of a light source, wherein the pixel values are determined using the modified material appearance parameter;
determining perceived coverage of the surface by specular highlights based on the pixel values weighted using the corresponding weighting coefficients; and
rendering the image using colour properties adjusted based on the determined coverage, to maintain perceived colour properties and update perceived gloss based on the modification.

2. The method according to claim 1, wherein the adjusted colour properties relate to at least one of colour saturation and colour lightness.

3. The method according to claim 1, wherein the user input modifying a material appearance parameter relates to at least one of modifying a mesoscale structure of the material, modifying physical gloss of the material, and modifying specular roughness of the material.

4. The method according to claim 1, wherein the user input modifying a material appearance parameter relates to at least one of modifying a mesoscale structure of the material, modifying physical gloss of the material, and modifying specular roughness of the material, and wherein the mesoscale structure relates to one of bumpiness and height.

5. The method according to claim 1, wherein the user input modifies a mesoscale geometry of the material, and a specular roughness parameter is adjusted to maintain a perceived colour saturation of the surface.

6. The method according to claim 1, the user input modifies a mesoscale geometry of the material, and a specular roughness parameter is adjusted to maintain a perceived colour saturation of the surface, and the specular roughness is adjusted using a polynomial function of the parameters modified by the user input, and coefficients of the polynomial function are obtained from psychophysical experiment data.

7. The method according to claim 1, wherein a ratio of an updated perceived colour property to an initial perceived colour property is used to modify a diffuse colour property of the surface to thereby maintain the perceived colour properties.

8. The method according to claim 1, wherein the user input modifies a mesoscale geometry of the material, and a specular roughness parameter is adjusted to maintain a perceived colour saturation of the surface and the adjusted specular roughness parameter is determined from a look-up-table derived from psychophysical experiment data.

9. The method according to claim 1, wherein the coverage of the surface by specular highlights is determined by comparing each weighted pixel to a pre-determined threshold.

10. The method according to claim 1, wherein the coverage of the surface by specular highlights is determined by comparing each weighted pixel to a pre-determined threshold, and the threshold is determined according to surface reflectance properties, surface diffuse colour and lighting environment information.

11. The method according to claim 1, wherein perceived colour properties are determined as a weighted combination of the perceived coverage and perceived gloss.

12. The method according to claim 1, wherein the weighting comprises mapping normals of each pixel to a greyscale intensity.

13. The method according to claim 1, wherein the colour properties are adjusted across R, G, and B colour channels.

14. The method according to claim 1, further comprising estimating a perceived colour saturation for given colour and gloss prior to receiving the user input.

15. The method according to claim 1, wherein perceived colour saturation is determined as a linear combination of statistics of specular coverage or statistics of specular content of the weighted pixels.

16. The method according to claim 1, wherein the colour properties are adjusted by adjusting colour saturation using a polynomial function, the coefficients of the polynomial function being determined from psychophysical experiment data.

17. The method according to claim 1, wherein the colour properties are adjusted by adjusting colour saturation using a look-up-table representing a mapping between colour saturation and material appearance parameters relating perceived gloss.

18. An apparatus comprising:
a processor; and
a memory device storing a software program for directing the processor to perform a method for rendering an image of a surface, the method comprising the steps of:
receiving a user input modifying a material appearance parameter of the surface related to perceived gloss;
determining a weighting coefficient for each of a plurality of pixel values of the surface using a corresponding normal, viewing angle and a position of a light source, wherein the pixel values are determined using the modified material appearance parameter;
determining perceived coverage of the surface by specular highlights based on the pixel values weighted using the corresponding weighting coefficients; and
rendering the image using colour properties adjusted based on the determined coverage, to maintain perceived colour properties and update perceived gloss based on the modification.

19. A system comprising:
a processor; and
a memory device storing a software program for directing the processor to perform a method of rendering an image of a surface, the method comprising the steps of:
receiving a user input modifying a material appearance parameter of the surface related to perceived gloss;
determining a weighting coefficient for each of a plurality of pixel values of the surface using a corresponding normal, viewing angle and a position of a light source, wherein the pixel values are determined using the modified material appearance parameter;
determining perceived coverage of the surface by specular highlights based on the pixel values weighted using the corresponding weighting coefficients; and
rendering the image using colour properties adjusted based on the determined coverage, to maintain perceived colour properties and update perceived gloss based on the modification.

20. A non-transient computer readable storage medium storing program instructions to implement a method of:
reproducing, via a graphical user interface, an initial image of the surface;
receiving, via the graphical user interface, a user input modifying perceived gloss of the surface;
determining a colour saturation value corresponding to the received user input, wherein the colour saturation value varies depending on perceived gloss of the surface associated with the user input;
rendering, via the user interface, the image using colour properties adjusted based on the determined colour saturation, to maintain perceived colour saturation and update perceived gloss based on the modification; and
displaying the rendered image via the graphical user interface.

21. The computer readable medium according to claim 18, wherein the colour properties are adjusted based upon a perceived specular coverage of the surface.
